(19) United States
(12) Patent Application Publication
(10) Pub. No.: US 2008/0101654 A1
(43) Pub. Date: May 1, 2008

(54) Information displaying method and information display terminal device

(75) Inventor: Shoichi Sano, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/710,581

(22) Filed: Feb. 26, 2007

(30) Foreign Application Priority Data
Oct. 30, 2006 (JP) 2006-293677

(51) Int. Cl. G06K 9/46

(52) U.S. Cl. 382/103; 382/190

(57) ABSTRACT

States of respective targets such as persons, buildings, and the like are expressed, on the basis of information such as various sensor data obtained from the targets, in analog quantities such as the size, color, color depth, and the like of geometric figures, and are displayed in a terminal or the like.

### BACKGROUND OF THE INVENTION

1. Field of the Invention

The present invention relates to an information displaying method used for displaying, on remote terminals or the like, states of persons, buildings or the like.

2. Description of the Related Art

In recent years, mobile terminals such as mobile phones have been widely used, and networks have advanced to cover wider areas and to be of lower cost.

Also, there have been demands for the states of remote persons or buildings (such as the safety of elderly people living by themselves, the current location of a child, the state of a house whose dwellers are out of the house, and the like) to be able to be arbitrarily confirmed, and systems that respond to such demands, i.e., information-on-safety displaying systems, have been suggested in recent years. These systems display in remote terminals or the like information on persons, buildings and the like about whom/which it is desired to confirm safety or other such states (Patent Documents 1 and 2 for example).

Further, systems are also suggested that are used for reporting states of another person to a particular person, and provide information on the basis of various pieces of information obtained from a mobile terminal such as the states of the mobile terminal carried by that other person, the states of operations performed on the mobile terminal by that other person, the position information obtained by using a GPS (Global Positioning System) mounted on the mobile terminal, and the like (Patent Document 3 for example). Also, Patent Document 4 discloses a technique by which states of remote persons are expressed by using a communication tool called an avatar on networks.

However, among the conventional information-on-safety displaying systems, there is not a system that displays various pieces of information respectively obtained from a large number of targets such as persons, buildings and the like in an integrated manner, and by which a user viewing the information can grasp the states of respective targets briefly and intuitively.

### Patent Document 1

Japanese Patent Application Publication No. 2003-108671

### Patent Document 2

Japanese Patent Application Publication No. 2005-31984

### Patent Document 3

Japanese Patent Application Publication No. 2002-158610

### Patent Document 4

Japanese Patent Application Publication No. 2005-354389

### SUMMARY OF THE INVENTION

In view of the above, it is an object of the present invention to provide an information displaying method by which information is provided to users who desire to obtain information on states of targets such as, for example, persons, buildings and the like, and is provided in such a manner that the users can grasp the states of the respective targets briefly and intuitively on the basis of a large number of respective pieces of information obtained from such targets.

In order to attain the above object in the information displaying method according to the present invention, states of the targets are displayed on terminals or the like in the form of analog quantities such as geometric figure shape, figure size, color, color depth and the like; states are displayed on the basis of information such as various sensor data obtained from targets such as persons, buildings and the like (this data is referred to as various state data). Thereby, the users viewing the information can grasp the states of a plurality of targets briefly and intuitively.

### BRIEF DESCRIPTION OF THE DRAWINGS

FIG. 1 shows an example of the entire configuration of the information-on-safety displaying system;

FIG. 2 shows a hardware configuration of a safety-confirmation server;

FIG. 3 is a function block diagram showing the safety-confirmation server;

FIG. 4 shows a flowchart for the safety-confirmation server;

FIG. 5 shows the hardware configuration of a state data reporting terminal device or an information display terminal device;

FIG. 6 is a function block diagram of the state data reporting terminal device;

FIG. 7 is a function block diagram of the information display terminal device;

FIG. 8 shows a configuration of a conversion table;

FIG. 9 shows a process flow of the state data reporting terminal device;

FIG. 10 shows a process flow of the information display terminal device;

FIG. 11 shows the configuration of the state data that is transmitted to the safety-confirmation server from the state data reporting terminal device;

FIG. 12 shows the configuration of the data transmitted from the safety-confirmation server to the information display terminal device;

FIG. 13 shows an example of a display screen in the information display terminal device;

FIG. 14A shows when only electricity is being used;

FIG. 14B shows when only water is being used;

FIG. 14C shows when electricity and water are both being used;

FIG. 14D shows when only electricity is being used, wherein a large amount of electricity is being used;

FIG. 14E shows when electricity and water are both being used, wherein a large amount of electricity is being used;

FIG. 15A shows when a gas main is open;

FIG. 15B shows when gas is being used;

FIG. 15C shows when a large amount of gas is being used;

FIG. 16A shows when a door on the first floor is open;

FIG. 16B shows when a door on the first floor and a window on the second floor are open;

FIG. 17 shows an example of displaying the circle 1304 shown in FIG. 13;

FIG. 18A shows the system when the terminal is not operated frequently, but is moved greatly;

FIG. 18B shows the system when the terminal is operated frequently, but is not moved greatly;

FIG. 19A shows an example of a display before simplification;

FIG. 19B shows an example of the simplified display;

FIG. 20A shows an example of a display before something is displayed in detail;

FIG. 20B shows an example of a display in detail;

FIG. 21A shows an example of a display before displaying character information in detail; and

FIG. 21B shows an example of a display of character information.

### DESCRIPTION OF THE PREFERRED EMBODIMENTS

Hereinbelow, examples of the present invention will be explained by referring to the drawings.

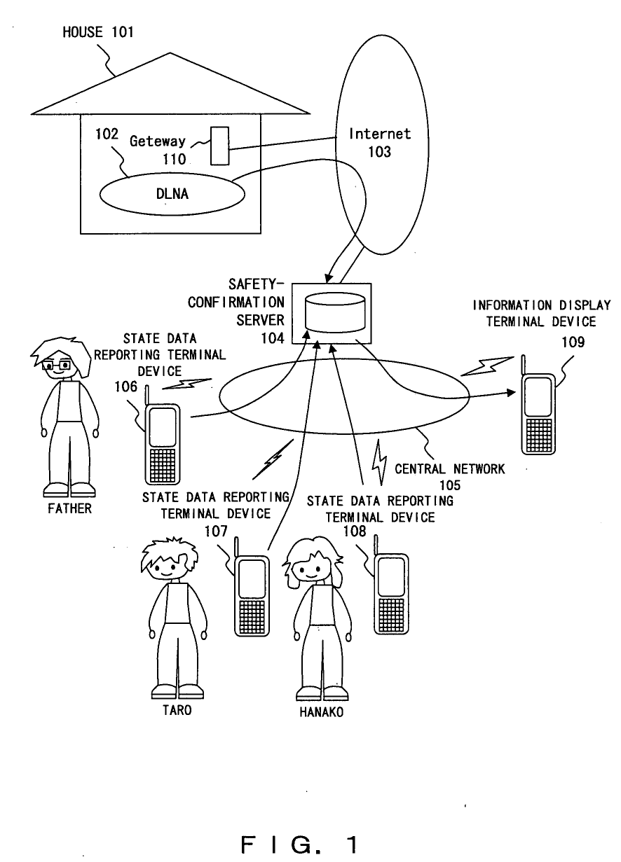

FIG. 1 shows the configuration of an entire information-on-safety displaying system that is an example of the present invention.

A central network 105 includes a safety-confirmation server 104 for collecting state data of targets such as persons, buildings, and the like. In the present example, the state data refers to various data obtained through various sensors installed in buildings, sensors included in mobile terminals carried by persons, and the like.

The safety-confirmation server 104 receives, through a gateway 110 and the Internet, the state data transmitted at a constant time interval from the various sensors connected to a home network such as a DLNA (Digital Living Network Alliance) network 102. Examples of the various sensors provided in a house 101 and connected to the home network include the sensors as listed below.

Door/window open and close detection sensor (a sensor for detecting the open/closed state of doors and windows)

Gas/smoke detection sensor (a sensor for detecting gas leaks and smoke)

Electricity circuit breaker/gas main sensor (a sensor for detecting the state of electricity circuit breakers and gas mains)

Temperature sensor (a sensor for detecting temperature)

Electricity use amount sensor (a sensor for detecting the amount of electricity being used)

Gas use amount sensor (a sensor for detecting the amount of gas being used)

Water use amount sensor (a sensor for detecting the amount of water being used)

Communication network use frequency sensor (a sensor for detecting the frequency of use of communication networks)

Also, the safety-confirmation server 104 receives the state data reported at a constant time interval from the various sensors included in mobile terminal devices (state data reporting terminal devices) 106, 107, and 108. Hereinafter, the mobile terminal devices 106, 107, and 108 are referred to as state data reporting terminals. Examples of the sensors included in the state data reporting terminal devices include the sensors as listed below.

Acceleration/angle sensor (a sensor for detecting states of movement of the state data reporting terminal device)

GPS sensor (a sensor for detecting position information of the state data reporting terminal device)

Temperature/brightness/pressure sensor (a sensor for detecting the environmental state of the state data reporting terminal device)

Input/output device operational state detection sensor (a sensor for detecting operational states of input/output devices such as cameras, IrDA (Infrared Data Association) devices, or the like that are included in the state data reporting terminal device)

IC card or SUICA (registered trademark of East Japan Railway Company) operational state sensor (a sensor for detecting operational states of an IC card)

Button operation sensor (a sensor for detecting the operational states of buttons)

Telephone conversation/communication packet state sensor (a sensor for detecting states of telephone conversations and measuring communication packet amounts)

Electric power sensor (a sensor for detecting whether the state data reporting terminal device is in an on-state or an off-state)

Mode state detection sensor in FMC (Fixed Mobile Convergence) (a sensor for detecting whether the state data reporting terminal device is performing communications in the cellular mode or the WLAN mode)

Total communication time period sensor (a sensor for detecting the total communication time period in the state data reporting terminal device)

Remaining battery power sensor (a sensor for detecting the remaining battery power of the state data reporting terminal device)

TV view/TV function operational state sensor (a sensor for detecting the use state of television functions in the state data reporting terminal device)

An information display terminal device 109 makes requests for information to the safety-confirmation server 104 at a constant time interval. Receiving this request, the safety-confirmation server 104 organizes the state data obtained from the house 101 and the state data reporting terminal devices 106, 107, and 108, and transmits the organized data to the information display terminal device 109. In the information display terminal device 109, information to be displayed is created and is displayed on the basis of the plurality of state data received from the safety-confirmation server 104. The specific methods for creation of the information to be displayed will be described later.

In FIG. 1, the state data reporting terminal devices 106, 107, and 108, and the information display terminal device 109 are illustrated as mobile telephones, however, the state data reporting terminal devices 106, 107, and 108 can be any type of information terminal devices that are portable, and the information display terminal device 109 can be any type of information terminal devices by which information can be viewed.

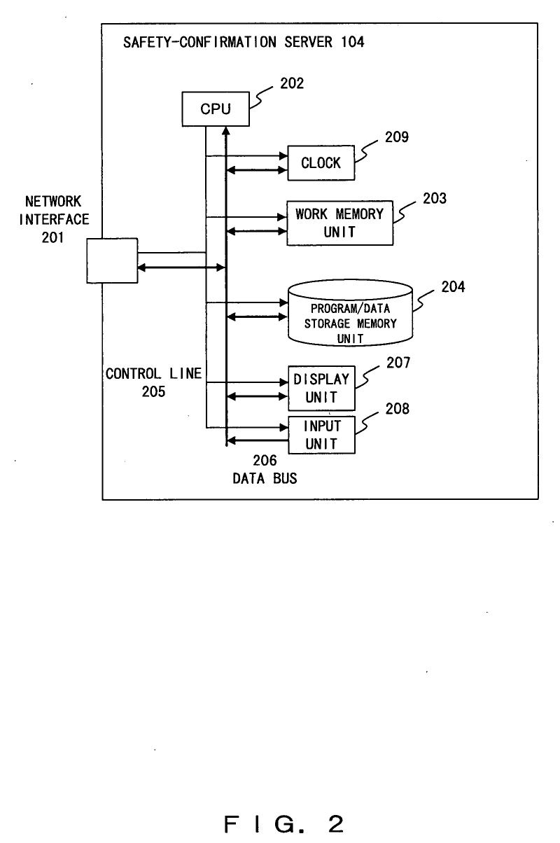

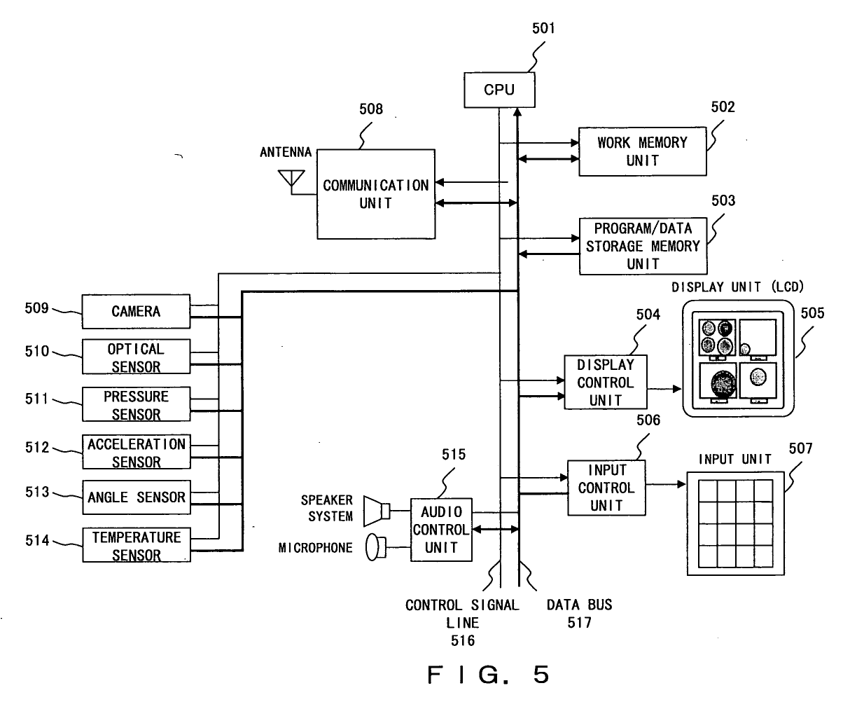

Next, the configuration in detail and the process flow of the safety-confirmation server 104 are shown in FIGS. 2 through 4, and the configuration in detail and the process flow of the state data reporting terminal devices 106, 107, and 108 and the information display terminal device 109 are shown in FIGS. 5 through 9.

FIG. 2 shows the hardware configuration of the safety-confirmation server 104.

The safety-confirmation server 104 employs a configuration in which the following are bus-connected to one another through a data bus 206 and a control line 205: a network interface 201 that is connected to the network and controls the communications; a CPU (Central Processing Unit) 202 that functions as a processing unit; a work memory unit 203 that consists of RAM (Random Access Memory) or the like; a program/data storage memory unit 204 that consists of a ROM (Read Only Memory) unit, a hard disk or the like; a display unit 207 that controls a display on a screen; and an input unit 208 that processes signals input from input devices such as a keyboard, a mouse, and the like.

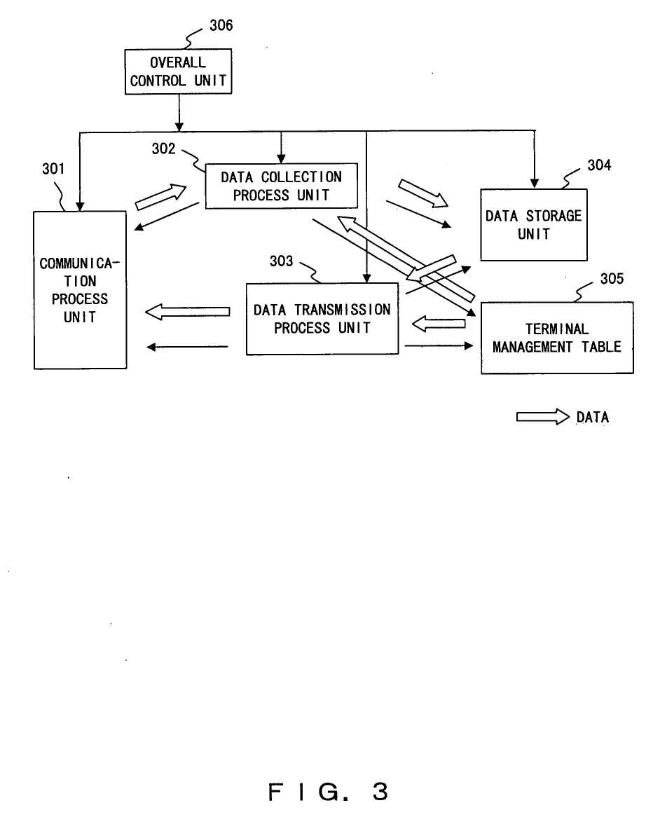

FIG. 3 is a function block diagram showing the safety-confirmation server 104.

In FIG. 3, an overall control unit 306 performs overall control of respective units including a communication process unit 301, a data collection process unit 302, a data storage unit 304, a data transmission process unit 303, a terminal management table 305, and the like. The data collection process unit 302 performs communications with the respective state data reporting terminal devices 106 through 108 and the house 101 via the communication process unit 301 while referring to the terminal management table 305 that is managing the state data reporting terminal devices 106 through 108, and collects the state data from the respective state data reporting terminal devices 106 through 108 in order to record the data in the data storage unit 304.

The data transmission process unit 303 performs communications with the information display terminal device 109 via the communication process unit 301 while referring to the terminal management table 305, and performs the process of transmitting the state data to the information display terminal device 109.

The terminal management table 305 defines the state data reporting terminal devices 106 through 108 and the house 101 whose states can be referred to in the information display terminal device 109, and is used for determining whether or not data can be transmitted in response to the requests from the information display terminal device 109.

Additionally, the overall control unit 306, the communication process unit 301, the data collection process unit 302, and the data transmission process unit 303 shown in FIG. 3 are realized in the form of programs recorded in the program/data storage memory unit 204 shown in FIG. 2, and are executed by the CPU 202 by using the work memory unit 203 or a similar device or unit. Also, the data storage unit 304 and the terminal management table 305 are stored in the program/data storage memory unit 204.

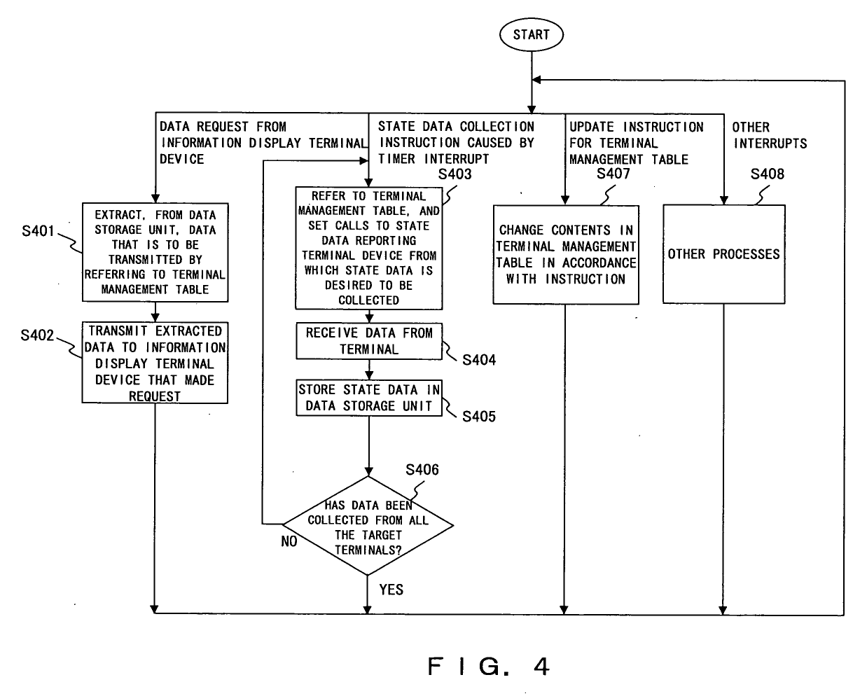

FIG. 4 shows a flowchart for the safety-confirmation server 104.

The process is branched depending on whether the instruction given to the safety-confirmation server 104 is “data request from information display terminal device 109”, “state data collection instruction caused by timer interrupt”, “update instruction for terminal management table”, or “other interrupts”.

When the instruction is “data request from information display terminal device 109”, the process proceeds to S401, refers to the terminal management table 305, and extracts from the data storage unit 304 the state data that is to be transmitted. Then, the process transmits the extracted data to the information display terminal device 109 that made the request in S402.

When the instruction is “state data collection instruction caused by timer interrupt”, the process proceeds to S403, refers to the terminal management table 305, and sets calls to the state data reporting terminal devices 106 through 108 and the like from which the state data is desired to be collected. In S404, the state data is received from the state data reporting terminal devices 106 through 108 and the house 101. In S405, the received state data is stored in the data storage unit 304. In S406, it is determined whether or not the state data has been collected from all the targets of the state data reporting terminal devices 106 through 108 and the house 101. If the data collection from all of the targets is not finished, the process returns to S403, and the above operation is repeated.

Also, when the instruction is “update instruction for terminal management table 305”, the contents in the terminal management table 305 are changed in accordance with the instruction in S407.

When the instruction is “other interrupts”, the interrupt process is executed in S408.

The safety-confirmation server 104 in the present example of the present invention has been explained in detail by referring to FIGS. 2 through 4.

Next, the state data reporting terminal devices 106 through 108 and the information display terminal device 109 according to the present invention will be explained in detail by referring to FIGS. 5 through 9.

FIG. 5 shows the hardware configuration of a terminal device for realizing the state data reporting terminal devices 106 through 108 and the information display terminal device 109. Additionally, FIG. 5 shows a configuration employing mobile telephones as examples of state data reporting terminal devices 106 through 108 and the information display terminal device 109; however, any type of device having the equivalent functions for realizing the present example can be employed.

Each of the state data reporting terminal devices 106 through 108 and the information display terminal device 109 employs the configuration in which the following are bus-connected to one another through a data bus 517 and a control signal line 516: a CPU 501, a work memory unit 502 that consists of a RAM (Random Access Memory) unit or the like; a program/data storage memory unit 503 that consists of a ROM (Read Only Memory) unit, a hard disk or the like; a display control unit 504 that controls information displayed on a display unit (LCD) 505; an input control unit 506 that processes a signal input from an input unit 507 consisting of input buttons or the like; an audio control unit 515 that controls audio output signals such as signals output from a speaker system and input into a microphone; a radio communication unit 508 that controls radio communications; and various sensors (such as a camera 509, an optical sensor 510, a pressure sensor 511, an acceleration sensor 512, an angle sensor 513, or a temperature sensor 514). It is to be noted that the respective sensors shown in FIG. 5 are examples, and other sensors can be included in the configuration.

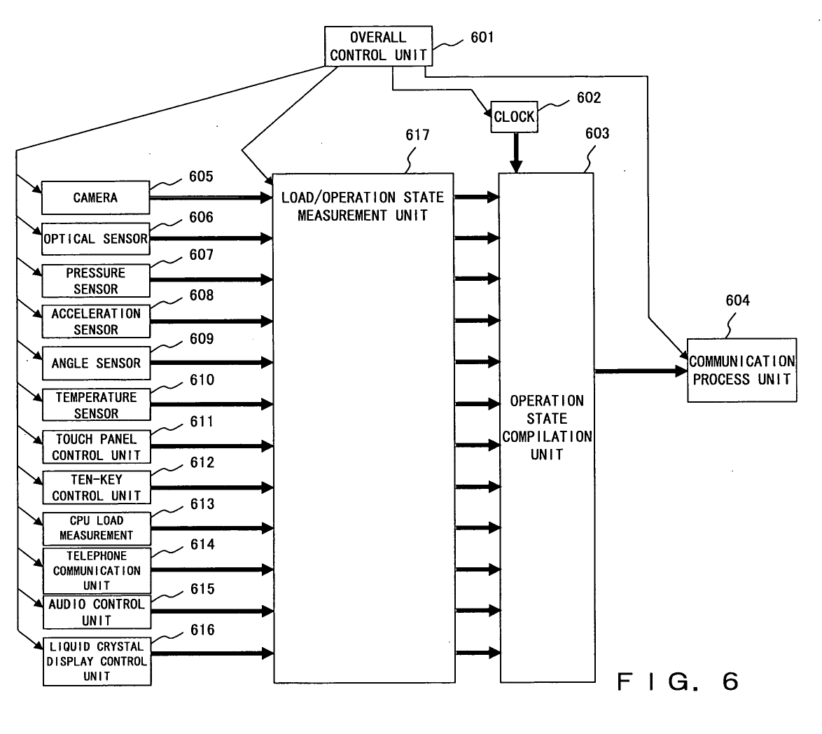

FIG. 6 shows a function block diagram of each of the state data reporting terminal devices 106 through 108 shown in FIG. 5.

In FIG. 6, an overall control unit performs the overall controls on respective units, including a communication process unit 604, an operation state compilation unit 603, a load/operation state measurement unit 617, and respective sensors 605 through 616. A clock 602 has a clocking function.

Raw data is collected from the camera sensors 605 that detect use states of the cameras included in the state data reporting terminal devices 106 through 108, the optical sensors 606 that measure the brightness of the environments around the state data reporting terminal devices 106 through 108, the pressure sensors 607 that measure the pressure in the environments around the state data reporting terminal devices 106 through 108, the acceleration sensors 608 that measure the acceleration of the state data reporting terminal devices 106 through 108 when being moved, the angle sensors 609 that measure the angles of the state data reporting terminal devices 106 through 108 when being moved, the temperature sensors 610 that measure the temperature in the environments around the state data reporting terminal devices 106 through 108, the touch panel control units 611 that detect the control state of touch panels serving as the input interfaces in the state data reporting terminal devices 106 through 108, the ten-key control units 612 that detect control states of the ten-key keypads serving as the input interfaces in the state data reporting terminal devices 106 through 108, the CPU load measurement units 613 that measure loads on the CPUs 601, the telephone communication units 614 that detect the telephone communication states in the state data reporting terminal devices 106 through 108, the audio control units 615 that detect the states of music listened to through the state data reporting terminal devices 106 through 108, and the liquid crystal display control units 616 that detect the display control states in the display units in the state data reporting terminal devices 106 through 108. This raw data is processed, in the load/operation state measurement units 617, into pieces of information by which the loads, the operation states and the like can be measured, and these pieces of information are compiled in the operation state compilation units 603 and are sent to the safety-confirmation server 104 via the communication process units 604.

Additionally, the overall control unit 601, the load/operation state measurement unit 617, the operation state compilation unit 603, and the communication process unit 604 shown in FIG. 6 are realized in the form of programs recorded in the program/data storage memory unit 503 shown in FIG. 5, and are executed by the CPU 501 by using the work memory unit 502 or the like.

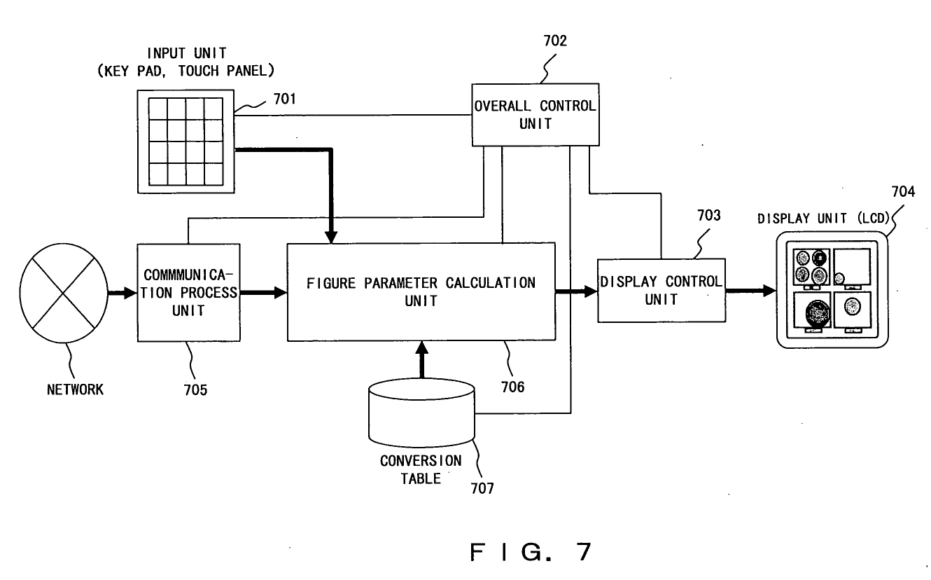

FIG. 7 shows a function block diagram of the information display terminal device 109. An overall control unit 702 performs the overall controls on respective units, including a communication process unit 705, a figure parameter calculation unit 706, a display control unit 703 and the like. The state data of the state data reporting terminal devices 106 through 108 and the house 101 is obtained from the safety-confirmation server 104 via the communication process unit 705, which can be a central network 105, is converted into figure parameters in the figure parameter calculation unit 706 with conversion tables 707 referred to, and is used for displaying geometric figures. The conversion tables 707 define the conversion methods for converting state data into figures.

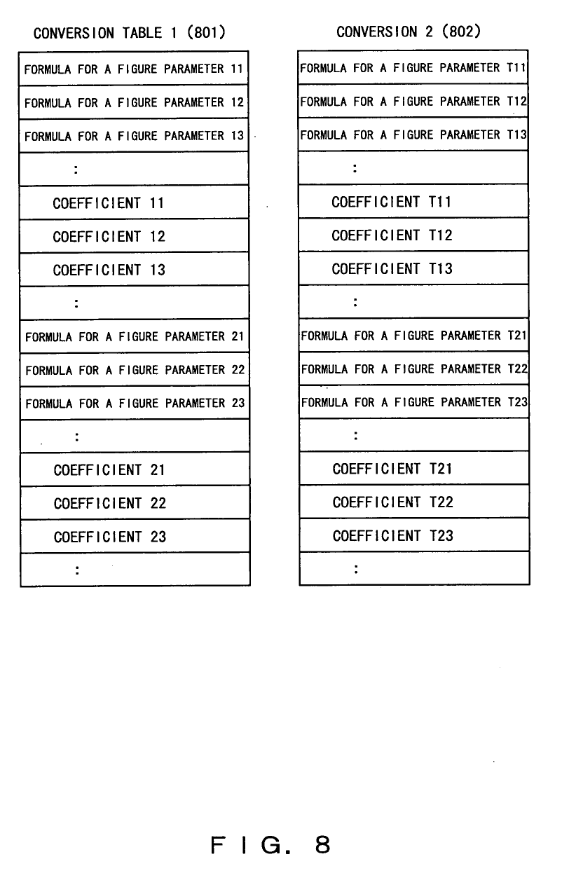

An example of the conversion tables 707 is shown in FIG. 8. FIG. 8 shows conversion table 1 (801) and conversion table 2 (802). The information display terminal device 109 has the following functions: a “simplified display” function by which, in response to a request from the user, a plurality of geometric figures respectively displaying the states of the targets are integrated such that the plurality of states of the targets can be displayed in one geometric figure, and a “display in detail” function by which, in response to a request from the user, the respective state data constituting the geometric figures of the respective targets are divided and are displayed. The information display terminal device 109 includes the conversion tables 707, which respectively correspond to the display methods, specifically, “normal display”, “simplified display”, and “display in detail” and the like. The conversion tables 1 (801) and 2 (802) shown in FIG. 8 are examples respectively showing the conversion tables for the normal display and the simplified display.

In FIG. 8, each table consists of formulas used for determining figure parameters (“formula for a figure parameter 11”, “formula for a figure parameter 12”, “formula for a figure parameter 13”, . . . , “formula for a figure parameter 21”, “formula for a figure parameter 22”, “formula for a figure parameter 23”, . . . , “formula for a figure parameter T11”, “formula for a figure parameter T12”, “formula for a figure parameter T13”, . . . , “formula for a figure parameter T21”, . . . , “formula for a figure parameter T23”, . . . ) and coefficients defined in the formulas (“coefficient 11”, “coefficient 12”, “coefficient 13”, . . . “coefficient 21”, “coefficient 22”, “coefficient 23”, . . . “coefficient T11”, “coefficient T12”, “coefficient T13”, . . . “coefficient T21”, “coefficient T22”, “coefficient T23”, . . . ). The respective formulas and coefficients that constitute the conversion tables can be set and changed arbitrarily by users.

Here, FIG. 7 is further explained. The display control unit 703 displays information on the display unit (LCD) 704 on the basis of the figure parameters calculated by the figure parameter calculation unit 706 by using the conversion tables 707. Additionally, when users using the information display terminal device 109 change the settings of the conversion tables 707, the input signals input through the input unit 701, which can be a key pad, a touch panel or the like, are transferred to the figure parameter calculation unit 706, and the input information is reflected in the conversion tables 707 or in another such medium.

In addition, even though the information display terminal device 109 comprises the figure parameter calculation unit 706 for converting the state data into the figure parameters in the present example, it is possible for the safety-confirmation server 104 to instead comprise the figure parameter calculation unit 706.

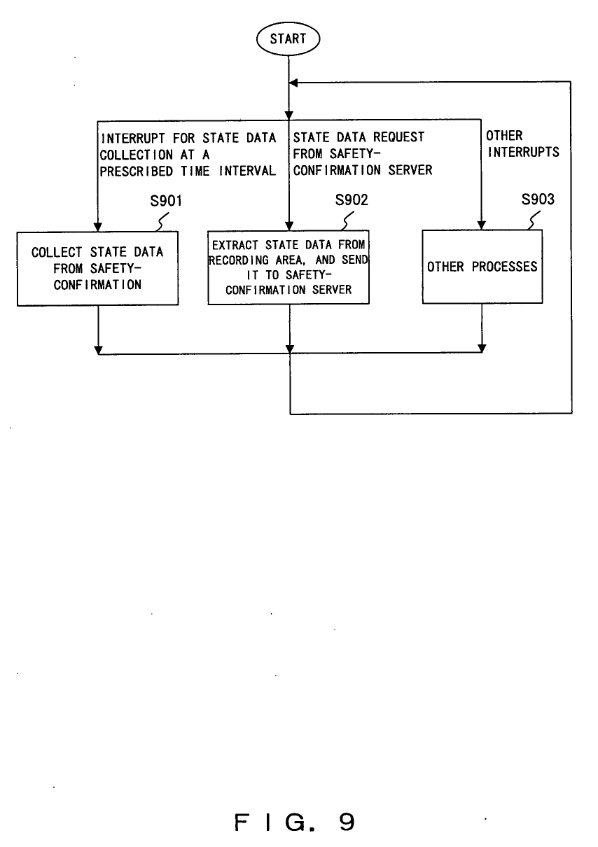

Next, the process flow of the state data reporting terminal devices 106 through 108 is shown in FIG. 9.

After the activation, the first branching of the process depends on whether the process is activated by “interrupt for state data collection at a prescribed time interval”, “data request from safety-confirmation server”, or “other interrupts”.

When the process is activated by “interrupt for state data collection at a prescribed time interval”, sensor information is collected from the respective sensors, and the collected information is stored as the state data in a recording area (such as the work memory unit 502 or the program/data storage memory unit 503 shown in FIG. 5) in S901.

When the process is activated by “data request from image display terminal”, the state data is extracted from the recording area and is sent to the safety-confirmation server 104 in S902.

When the process is activated by “other interrupts”, processes for “other interrupts” are executed in S903.

Additionally, because there is a capacity limit for the recording area in each of the state data reporting terminal devices 106 through 108, when the recording area is fully occupied, the state data is deleted in the order starting from the oldest state data, which is not shown in FIG. 8.

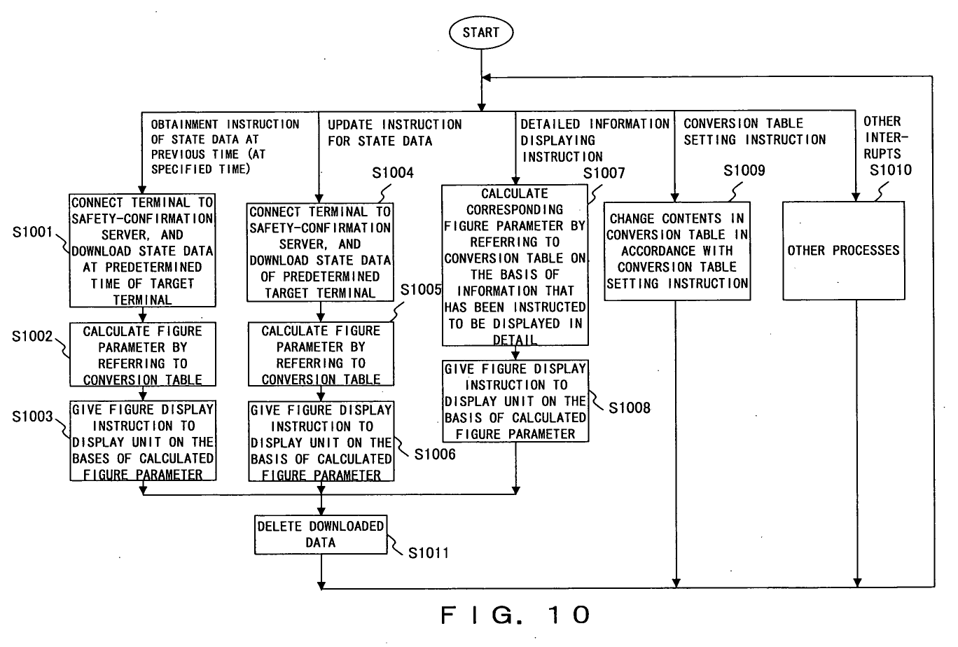

FIG. 10 shows the process flow of the information display terminal device 109.

After the activation, the first branching of the process depends on whether the process is activated by the “obtainment instruction of state data at a previous time (at a specified time)”, the “update instruction for state data”, the “detailed information displaying instruction”, the “conversion table setting instruction”, or by “other interrupts”.

When the process is activated by the “obtainment instruction of state data at a previous time (at a specified time)”, the information display terminal device 109 is connected to the safety-confirmation server 104 and the state data on the predetermined target terminal and at the predetermined time is downloaded in S1001. Then, in S1002, the figure parameter is calculated by referring to the conversion table 707 on the basis of the obtained state data. In S1003, the figure display instruction is given to the display unit 704 on the basis of the calculated figure parameter.

When the process is activated by the “update instruction for state data”, the information display terminal device 109 is connected to the safety-confirmation server 104, and the state data of the predetermined target terminal is downloaded in S1004. In S1005, the figure parameter is calculated, on the basis of the obtained state data, by referring to the conversion table 707. In S1006, the figure display instruction is given to the display unit 704 on the basis of the calculated figure parameter.

When the process is activated by the “detailed information displaying instruction”, the corresponding figure parameter is calculated by referring to the conversion table 707 on the basis of the information for which instructions to be displayed in detail have been given in S1007. Then, in S1008, the figure display instruction is given to the display unit 704 on the basis of the calculated figure parameter.

After the display processes are respectively completed in S1003, S1006, and S1008, the downloaded data on the work memory unit 502 or similar unit is deleted (S1011).

Also, in the case of the “conversion table setting instruction”, the contents in the conversion tables are changed in accordance with the conversion table setting instruction in S1009.

When the process is activated by “other interrupts”, processes for “other interrupts” are executed in S1010.

The state data reporting terminal devices 106 through 108 and the information display terminal device 109 according to the present example have been explained in detail by referring to FIGS. 5 through 9.

As described above, in the information-on-safety displaying system according to the present example, the state data is reported from the state data reporting terminal devices 106 through 108 and the house 101 to the safety-confirmation server 104, the obtained state data is organized in the safety-confirmation server 104, the state data obtained from the safety-confirmation server 104 is converted into figure parameters in the information display terminal device 109, and a plurality of the state data is displayed as geometric figures on the display unit in the information display terminal device 109. The data structure employed when the state data or the like is exchanged between the respective devices is explained.

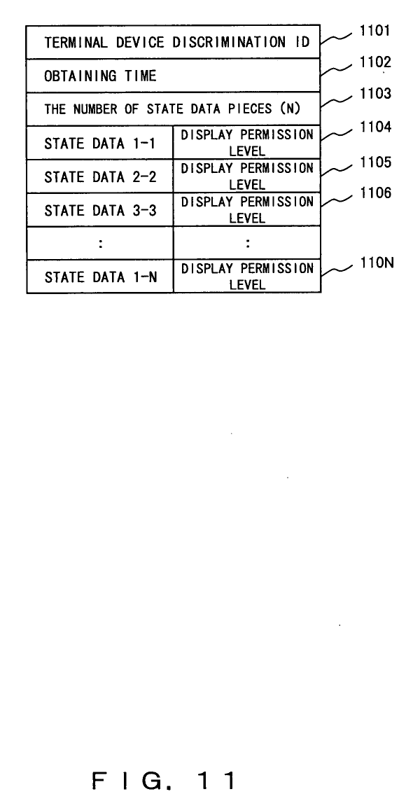

FIG. 11 shows the configuration of the state data that is transmitted to the safety-confirmation server 104 from the state data reporting terminal devices 106 through 108 and the house 101.

The state data includes a terminal device discrimination ID (1101) used for discriminating devices, the time (1102) at which the corresponding data was obtained, the number of data pieces constituting the state data (1103), and state data 1-1 through 1-N (1105 through 110N) corresponding to the respective sensors. Additionally, as the state data corresponding to the respective sensors, display permission levels are respectively set. To which of the information display terminal devices 109 the corresponding data can be provided is set on the basis of the display permission levels.

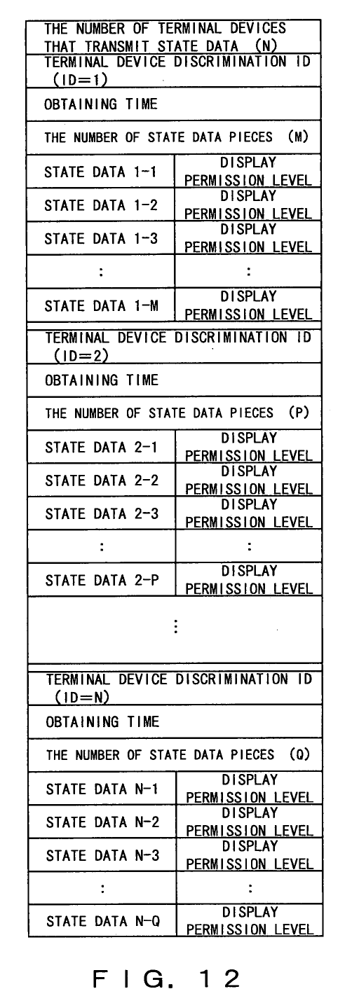

The state data shown in FIG. 11 is reported to the safety-confirmation server 104 at a constant time interval. The safety-confirmation server 104 stores in the storage unit 304 the received state data shown in FIG. 11. Then, as shown in FIG. 12, the safety-confirmation server 104 integrates the plurality of state data shown in FIG. 11 that were obtained from the respective terminal devices, and transmits the data to the information display terminal device 109 in response to a request for the state data made by the information display terminal device 109.

The configuration, operation, and the like of the information-on-safety displaying system according to the present example have been explained in detail in the above.

Next, the information display performed in the information display terminal device 109 in the above information-on-safety displaying system is explained in more detail.

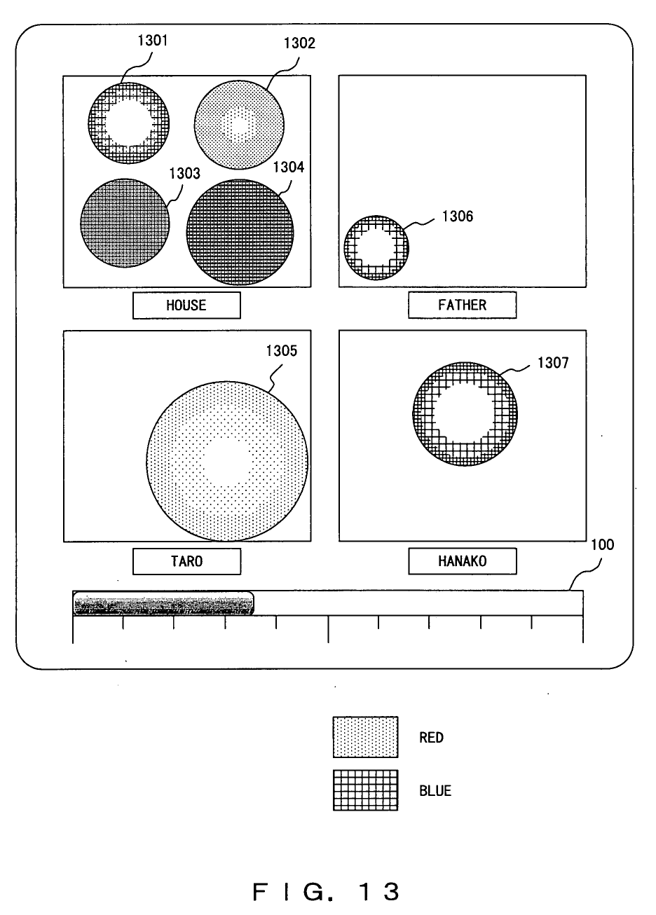

FIG. 13 shows an example of a display screen in the information display terminal device according to the present example.

In the present example, circles are used as the geometric figures. These geometric figures are displayed on the basis of the parameters for circles that are determined by a plurality of state data obtained from the respective targets. A parameter for a circle is information related to displaying a geometric figure, such as circle size (diameter), color, color depth (gradations), and position. Also, by operating a time indicator 1300 through the touch panel or similar device, a past state can be displayed.

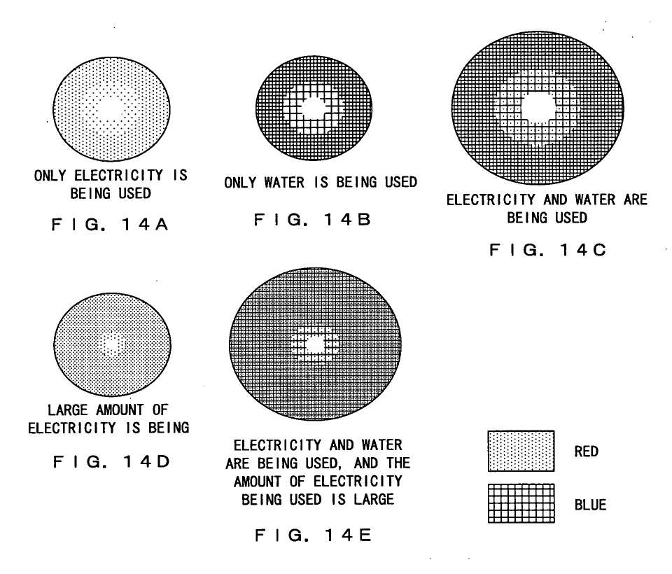

The determination of the figure parameters performed when the geometric figures are displayed is explained in detail by referring to FIG. 13. It is to be noted that the color depths of the circles shown in FIGS. 14, 15, 18, 19, 20, and 21 are changed steplessly in accordance with the diameters of the circles in the actual implementations; however, the depths in the drawings of the present application are expressed in three-step mode for greater convenience in preparing the drawings attached to this application. Also, in the colors of the circles, the latticed patterns represent blue and the dotted patterns represent red. For example, when purple must be displayed, the dotted pattern for representing red and the latticed pattern for representing blue are displayed in a superposed state.

Circles 1301, 1302, 1303, and 1304 representing the states of a house respectively express (1) the state of the electricity and water, (2) the state of the gas, (3) whether the doors are locked, and (4) the temperature and the usage state of communication lines. Circles 1305, 1306, and 1307 displayed in the portions for persons (father, Taro, and Hanako) respectively express the states of the corresponding persons as the fifth (5) element.

First, the circles expressing states (1) through (4) shown in the sections for the house are explained. Additionally, the coefficients K1 through K38 and P1 through P5 used below are set to simplify the display, and can be arbitrarily set and changed. Also, the sizes of the circles, the colors of the circles, the depths of the colors, and the positions of the circles used as the figure parameters are respectively referred to as ACT, MODE, NOUDO, and ICHI in the subsequent explanation.

### (1) State of Electricity and Water

The size (ACT) of each of the circles expresses the usage state of the electricity and water, and is determined by equation 1 below.

ACT=(DENKI+SUIDO)×K30+P1 (Equation 1)

### In the above equation,

DENKI is a value expressing whether or not electricity is being used, and is determined by the state data obtained from the safety-confirmation server; when DENKI=1, the electricity is being used, and when DENKI=0, the electricity is not being used.

SUIDO is a vale expressing whether or not water is being used, and is determined by the state data obtained from the safety-confirmation server; when SUIDO=1, water is being used, and when SUIDO=0, water is not being used.

The color (MODE) of each of the circles expresses whether or not electricity is being used, and whether or not water is being used, and is determined by equation 2 below.

MODE=(R,G,B)×NOUDO (Equation 2)

“(R, G, B)” is a method of expressing colors in information processing equipment such as computers or the like, where R, G, and B respectively express red, green, and blue in eight bits.

In equation 2 above, when R=1, electricity is being used, when R=0, electricity is not being used, when B=1, water is being used, when B=0, water is not being used, and G is always zero. NOUDO is a coefficient expressing the depth of each of the colors that changes from the center toward the periphery of the circle. This coefficient is determined by equation 3 below.

NOUDO=(K31×DE×r)+(K32×SU×r×r) (Equation 3)

### In the above equation,

DE is a value that expresses the amount of electricity being used; the state data obtained from the safety-confirmation server is substituted for DE.

SU is a value which expresses the amount of water being used; the state data obtained from the safety-confirmation server is substituted for SU.

r is the distance from the center (radius coordinates)

The figure parameters are determined as described above, and the states related to the use of electricity and water are expressed by the circles. The specific example is shown in FIG. 14.

FIG. 14A shows when only electricity is being used. Because only electricity is being used, the circle is displayed in red.

FIG. 14B shows when only water is being used. Because only water is being used, the circle is displayed in blue.

FIG. 14C shows when electricity and water are both being used. Because electricity and water are both being used, the circle is displayed larger in size (size expresses the number of resources being used), and is displayed in purple, which is the color obtained by mixing the colors of FIGS. 14A and 14B.

In the state shown in FIG. 14D, only electricity is being used, but the use amount of electricity is large; accordingly, the circle in FIG. 14D is displayed in red with a depth greater than that in FIG. 14A.

In the state shown in FIG. 14E, electricity and water are both being used, and the amount of electricity being used is great; accordingly, the redness is deeper to express that the amount of electricity being used is great.

With the configuration described above, the user viewing the information can grasp the amount of electricity and water being used by perceiving the sizes and color depths of the circles, and can also intuitively grasp whether water is being used or electricity is being used by perceiving the colors of the circles. It is possible to grasp the amount of electricity and water and the like that are being used much more briefly than in the configuration in which the amount of electricity and water being used are expressed by character information such as, for example, displaying that the water use amount is 15 cubic meters and the electricity use amount is 30 kWh.

Next, “(2) state of gas” is explained.

The size (ACT) of the circle expresses the use state of gas, and is determined by equation 4 below

ACT=GAS×K33+P2 (Equation 4)

In the above equation 4, GAS is a value that expresses whether or not the gas main is open or closed and is determined by the state data obtained from the state server. When GAS=1, the gas main is open, when GAS=0 the gas main is closed. The color (MODE) of the circle is a value expressing whether or not gas is being consumed, and is determined by equation 5 below.

MODE=(R,G,B)×NOUDO (Equation 5)

In equation 5 above, when R=1, gas is being used, when R=0, gas is not being used, and B and G are always zero. NOUDO is a coefficient expressing the depth of the color; this color changes from the center toward the periphery of the circle. This coefficient is determined by equation 6 below.

NOUDO=K34×GA×r (Equation 6)

### In the above equation,

GA is a value that expresses the amount of gas being used; the state data obtained from the safety-confirmation server is substituted for GA.

r is the distance from the center (radius coordinates)

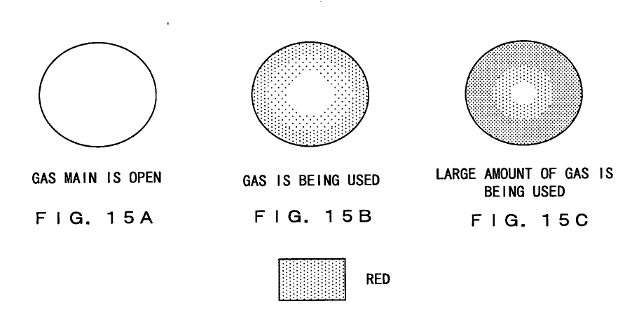

The figure parameters are determined as described above, and states related to gas usage are expressed by the circles. A specific example is shown in FIG. 15.

FIG. 15A shows when gas is not being used but the gas main is open. Because R=0 in the equation 5, the circle is white.

FIG. 15B shows when gas is being used. The circle is red and the color depth lessens from the outside to the center.

FIG. 15C shows when a large amount of gas is being used. The amount of gas being used is large in equation 6; accordingly, the circle shown in FIG. 15C is displayed in red with a depth greater than that shown in FIG. 15B, and in such a manner the color depth lessens from the outside to the center.

As described above, a user viewing this information can grasp whether or not the gas main is open or closed by perceiving whether or not the circle is displayed, and can also grasp whether or not a large amount of gas is being used by perceiving the color depth of the circle. It is easier to understand the state briefly and intuitively than in a configuration using character information or the like.

Next, the display of “(3) state of door locking” is explained.

The size (ACT) of the circle expresses whether or not a door or a window is open or closed, and is determined by equation 7 below.

ACT=K35×DOOR+P3 (Equation 7)

### In the above equation,

DOOR is a value that expresses whether or not a door is open or closed, and is determined by the state data obtained from the safety-confirmation server. When DOOR=1, the door is open, when DOOR=0, the door is closed. The color (MODE) of the circle is used for determining whether the corresponding item is a door or a window, and MODE=(R, G, B). When R=255, the door on the first floor is open, when R=0, the door on the first floor is closed, when G=255, the window on the first floor is open, When G=0, the window on the first floor is closed, when B=255, the window on the second floor is open, and when B=0, the window on the second floor is closed.

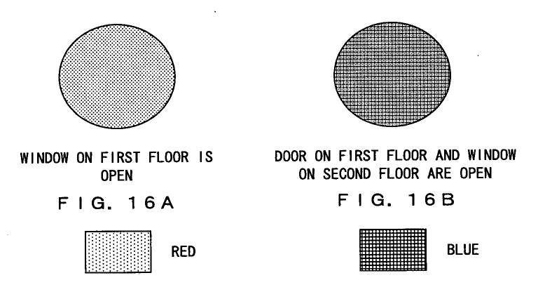

The figure parameters are determined as described above, and the states related to the door locking of the house are expressed by the circles. The specific example is shown in FIG. 16.

FIG. 16A shows a circle colored red, which indicates that the door on the first floor is open.

FIG. 16B shows a circle colored purple, which indicates that the windows on the first and second floors are open.

As described above, a user viewing this information can grasp whether or not there is a door that is not locked by perceiving whether or not the circle is displayed, and can also briefly grasp where the unlocked door or window is by looking at the displayed circle.

Next, “(4) use state of communication line and temperature” is explained.

The size (ACT) of the circle expresses whether or not communication is being performed, and is determined by equation 8 below.

ACT=K36×COM+P4 (Equation 8)

### In the above equation,

COM is a value that expresses whether or not communication is being performed, and is determined by the state data obtained from the safety-confirmation server. When COM=1, communication is being performed, when COM=0, communication is not being performed. The color (MODE) of the circle expresses the temperature in the house, and is determined by equation 9 below.

MODE=(R,G,B) (Equation 9)

where R=K37×temperature+K38, B=K37×temperature×(−1)+K38, and G is always zero.

The state data obtained from the safety-confirmation server is input into “temperature”.

Thereby, the circle is displayed in blue when the temperature is low, and is displayed in red when the temperature is high.

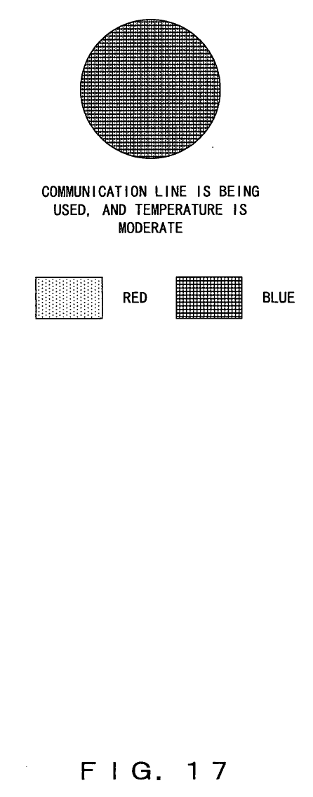

The figure parameters are determined as described above, and the states related to the temperature and the usage state of communication lines is expressed by the circles. A specific example is shown in FIG. 17. A user can understand that a communication line is being used by perceiving that the circle is displayed, and can also understand that the temperature is moderate by perceiving that the color of the circle is purple.

Next, “(5) state of persons” (father, Taro, and Hanako in the example of FIG. 13) is explained.

The states of the respective persons are displayed by obtaining their state data though mobile information terminal devices such as mobile phones carried by the respective persons.

In FIG. 13, figure parameters such as the size (ACT), the color (MODE), and the display position of, for example, the circle displayed in the space dedicated to the father are determined as described below.

The size (ACT) of the circle expresses how frequently the person operates the mobile terminal device, and is determined by equation (10) below.

ACT=K1×CAM+K2×IR+K2×IC+K3×T+K4×OPT+K5×PRESS+K6×BUTTON+K7×PACKET+P5 (Equation 10)

In the above, the state data obtained from the safety-confirmation server is input into CAM, IR, IC, T, OPT, PRESS, BUTTON, and PACKET. When CAM=1, the camera is in the on state, when CAM=0, the camera is in the off state. IR expresses the communication amount of the IrDA device per unit time (operation state of the IrDA device), IC expresses the communication amount of the IC card functions per unit time (operation state of the IC card functions), T expresses the temperature (value obtained by a thermometer), OPT expresses the amount of light received by the optical sensor, PRESS expresses the pressure amount on the pressure sensor, BUTTON expresses the number of operations performed on the buttons per unit time, and PACKET expresses the number of communication packets communicated per unit time.

Thereby, the radius of the circle becomes greater when the person frequently operates the mobile information terminal device, and the radius of the circle becomes smaller when the person does not frequently operate the mobile information terminal device. Accordingly, the activity state of the person can be grasped.

The color (MODE) of the circle expresses the state of communications in the mobile terminal device, and is determined by equation 11 below.

MODE=(R,G,B) (Equation 8)
where R=NOUDO×K10×255×CONNECT
   G=NOUDO×K11×255×ON
   B=NOUDO×K12×255×FMC

In the above equation, CONNECT, ON, and FMC are determined by the state data obtained from the safety-confirmation server; when CONNECT=0, communication is being performed, and when CONNECT=1, communication is not being performed. ON expresses whether or not the power of the mobile terminal device is in an on-state, and is always zero. FMC expresses which interface is used for the communication in the mobile information terminal having two wireless communication interfaces, i.e., cellular and WLAN; when FMC=0, WLAN is used, and when FMC=1, cellular is used. NOUDO expresses the Total communication time period and remaining battery power, and is determined by equation 12 below. NOUDO determines the depth changes from the center to the periphery in the circle.

NOUDO=(K20×T×r)+(K21×H×r×r) (Equation 12)

where T expresses the Total communication time period, into which the state data obtained from the safety-confirmation server is input, and H expresses the remaining battery power of the mobile information terminal device, into which the state data obtained from the safety-confirmation server is input, and r expresses the distance from the center of the circle (radius coordinates).

Thereby, it is possible to grasp the frequency of communication performed by the mobile information terminal device and the remaining battery power on the basis of the color depth change from the center toward the periphery in the displayed circle.

The position at which the circle is displayed expresses whether or not the amount of movement of the person carrying the mobile information terminal device or the like is large, and is determined by equation 13 below.

ICHI(x,y)=(K21×ACC,K22×KE) (Equation 13)

In the above equation, ACC expresses a value of the acceleration sensor, into which the state data obtained from the safety-confirmation server is input, and KE is a value of the angle sensor, into which the state data obtained from the safety-confirmation server is input.

Thereby, when the values of the acceleration sensor and the angle sensor are large, the circle is displayed in the upper-right portion on the display region because both x and y in (x, y) are large. Thereby, it is possible to briefly grasp whether or not the amount of movement of the person is large on the basis of the position of the circle.

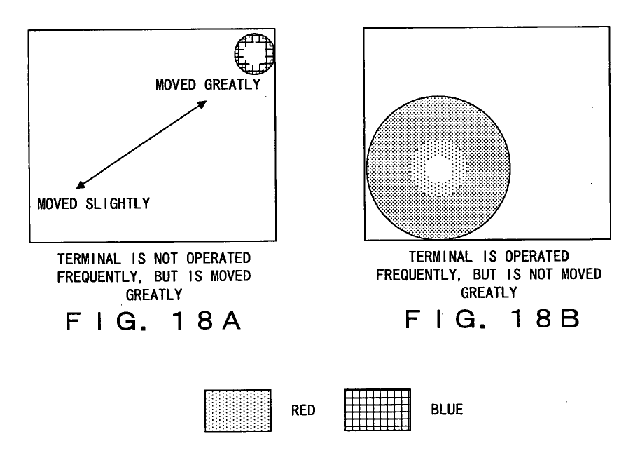

The figure parameters are determined as described above, and the state of the person is expressed by the circles. A specific example is shown in FIG. 18.

FIG. 18A shows a circle in which the radius is small, the color is blue, and the color depth changes abruptly; the circle is displayed in the upper-right portion of the display region. It is possible to know that the person carrying the mobile information terminal device does not use his or her terminal device frequently, that FMC communication is being performed, and that the terminal device is being moved a great amount.

FIG. 18B shows a circle in which the radius is large, the color is red, and the color depth changes gradually; the circle is displayed in the lower-left portion of the display region. Thereby, it can be understood that the target person frequently operates the mobile information terminal device that performs the cellular communication, and that the terminal device is not being moved much.

The methods of determining figure parameters have been explained in detail as described above by referring to FIGS. 14 through 18. The equations (equations 1 through 13) used for determining the figure parameters and the respective coefficients are stored in the conversion tables 707 shown in FIG. 7. In other words, in, for example, FIG. 8, the “formula for figure parameter 11” corresponds to equation 1, the “formula for figure parameter 12” corresponds to equation 2, . . . “coefficient 11” corresponds to K1, “coefficient 2” corresponds to K2, . . . , the “formula for figure parameter 21” corresponds to equation 4, and the “formula for figure parameter 22” corresponds to equation 5.

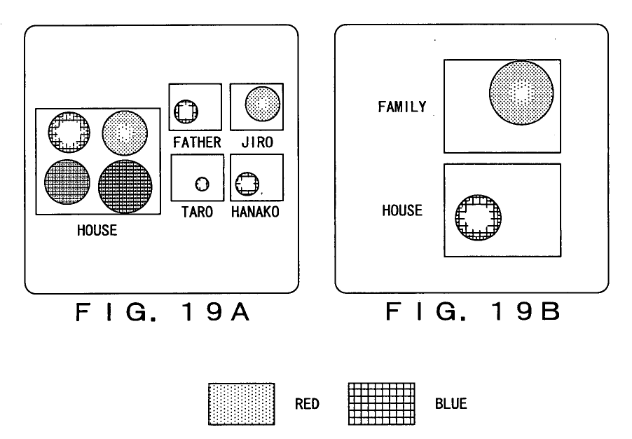

Additionally, in the information display terminal device 109 according to the present example, it is also possible to display a plurality of geometric figures corresponding to the targets in an integrated manner (simplified display), the geometric figures are displayed in a divided manner such that the geometric figures are displayed for each piece of state data (detailed display) instead of being displayed for each target, and the state data that constitutes the geometric figures is displayed in detail as character information (a detailed display is produced by using character information). Specific examples of a simplified display and a detailed display in the present example are shown in FIGS. 19 through 21.

In FIG. 19A, the states of a plurality of targets (father, Taro, and Hanako) are displayed on a screen, and the respective circles are small, which deteriorates legibility. FIG. 19B shows an example of the simplified display in which the circles corresponding to the respective persons are integrated, and the state of the whole family is displayed by one circle. Similarly, respective states such as gas, water, and electricity in the house are displayed in an integrated manner by one circle. Thereby, the information displayed on the screen is not displayed finely, and the legibility is not deteriorated.

When a plurality of geometric figures are integrated into one figure, figure parameters such as size, color, and color depth change can be determined by adding up the parameters of the respective circles, or can be determined by adding up the parameters that have been multiplied by the appropriate coefficients. The formulas and coefficients for determining the figure parameters for displaying the plurality of geometric figures in an integrated manner are stored in the conversion tables 707. On the basis of the conversion tables, the figure parameters are calculated by the figure parameter calculation unit 706, and the geometric figures are displayed in the display unit 704.

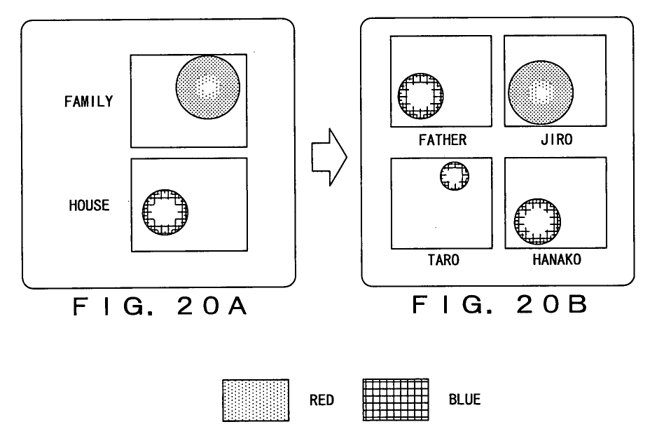

When it is desired that the plurality of pieces of information constituting one geometric figure be displayed separately and in detail, the respective pieces of information can be displayed in the form of corresponding figures in accordance with the selection of the figures made by operations on the touch panel or the buttons. An example of this display in detail is shown in FIG. 20. When the circle for the family in FIG. 20A is selected, the circles showing the states of the respective members of the family are displayed as in FIG. 20B.

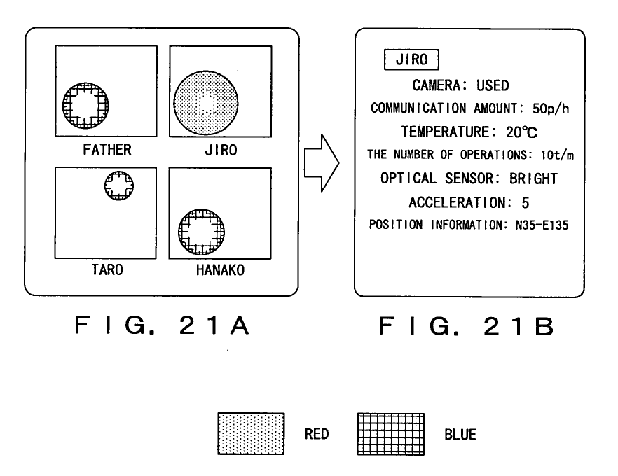

In the information display in the information display terminal device 109 according to the present example, the user can obtain the respective values, in the form of character information, of the state data that constitutes the geometric figures when the user needs more specific information and selects the respective geometric figures corresponding to the targets. FIG. 21 shows a display in detail in the form of character information. When “Jiro” is selected in FIG. 21A, the numerical values that constitute the circle for Jiro are displayed as a list as shown in FIG. 21B. The process in the information display terminal device 109 for this case is performed in such a manner that the figure parameter calculation unit 706 transfers to the display control unit 703 the character information (or numerical information), and the display control unit 703 causes the display unit 704 to display the character information.

As described above, the main object of the information display in the present example is to display the state data of a plurality of targets in an integrated manner such that the user can grasp the states of the targets briefly. However, it is also possible to display the state data of the plurality of targets in a simplified manner, to display the information in a divided state in detail, and to display the detailed information in the form of character information, which always realizes the provision of information that meets the user's requests.

The present example has been explained in detail; however, the scope of the present invention is not limited to the above. Specifically, although the figure parameter calculation unit is included in the information display terminal device 109 in the above explanation, the figure parameter calculation unit can instead be included in the safety-confirmation server 104. Also, in the above explanation, the information display terminal device 109 is realized in the form of a mobile information terminal device such as a mobile phone; however, the information display terminal device 109 can by any type of terminal device by which information can be viewed. Also, in the above explanation, the geometric figures displayed in the information display terminal device are circles; however, other figures or simple patterns that are legible to users may be used. The formulas and coefficients used for determining the figure parameters have been explained; however, the formulas or coefficients are not limited to these formulas or coefficients, and can be changed for legibility to and the convenience of users. Still further, any piece of information can be displayed in an integrated manner in response to the convenience of users.

Thus, the present invention is not limited to the above, and various configurations and shapes are allowed without departing from the spirit of the present invention.

In the information displaying method according to the present invention, the states of targets such as persons, buildings and the like are displayed in analog quantities such as the size, color, and color depth of geometric figures on the basis of information obtained from the targets through various sensors. Thereby, users viewing the information can grasp the states of a plurality of targets briefly and intuitively.

According to the information displaying method of the present invention, the states of the respective targets are displayed as the size, color and brightness of geometric figures on the basis of information (various state data) obtained from a large number of targets such as persons, buildings and the like through various sensors; accordingly, users viewing information can grasp the states of the targets in one glance, and can also grasp the states of all the targets at one time. Accordingly, the present invention can be applied to safety-confirmation servers used for confirming safety or the states of targets.

What is claimed is:

1. An information displaying method for displaying, in a terminal device, states of targets, comprising:
determining geometric figures corresponding to the targets and figure parameters for the geometric figures on the basis of a plurality of state data obtained from the targets; and
displaying, on a display screen in the terminal device, the geometric figures on the basis of the determined figure parameters for expressing states of the targets.

2. The information displaying method according to claim 1, wherein:
the figure parameters include size, color, and color depth of the geometric figures.

3. The information displaying method according to claim 1, wherein:
the plurality of state data obtained from the targets is composed of various data detected by various sensors included in mobile terminal devices carried by persons as the targets, and various data detected by various sensors installed in buildings as the targets.

4. The information displaying method according to claim 3, wherein:
the various sensors included in the mobile terminal devices include sensors for measuring an operation state of a camera in the mobile terminal device, an operation state of an infrared-ray communication device, a usage state of IC card functions, the number of operations performed on buttons per unit time, the number of communication packets communicated per unit time, total telephone conversation time period, remaining battery power, acceleration and angle in the mobile terminal device, and the position of the mobile terminal device; and
the various sensors installed in buildings as the targets include sensors for measuring electricity, gas, and water that are used in the buildings and the amount of communication performed in the buildings, and sensors detecting whether doors are locked.

5. The information displaying method according to claim 1, wherein:
a plurality of state data that are used for displaying geometric figures are divided into two or more combinations, figure parameters are respectively determined, and two or more geometric figures are displayed in detail on the basis of the figure parameters in response to a request from a user that is viewing information displayed on a display screen in the terminal device.

6. The information displaying method according to claim 1, wherein:
figure parameters of a plurality of geometric figures being displayed are integrated, new figure parameters are determined, and a simplified display in which a plurality of geometric figures are integrated into one geometric figure in order to be displayed on the basis of the new figure parameters is performed in response to a request from a user that is viewing information displayed on a display screen in the terminal device.

7. The information displaying method according to claim 1, wherein:
a plurality of state data that are used for displaying geometric figures are displayed in detail in the form of character information in response to a request from a user that is viewing information displayed on a display screen in the terminal device.

8. An information display terminal device for displaying states of targets, comprising:
figure parameter creation means for determining geometric figures corresponding to the targets and figure parameters for the geometric figures on the basis of a plurality of state data obtained from the targets; and
display control means for displaying, on a display screen in the information display terminal device, the geometric figures on the basis of the determined figure parameters.

9. The information display terminal device according to claim 8, wherein:
the plurality of state data obtained from the targets are various data detected by various sensors included in mobile terminal devices carried by persons as the targets, and various data detected by various sensors installed in buildings as the targets.

10. The information display terminal device according to claim 8, wherein:
the figure parameter creation means divides a plurality of state data that are used for displaying geometric figures into two or more combinations, determines respective figure parameters, and the display control means then displays two or more geometric figures on the basis of the determined figure parameters in response to a request from a user that is viewing information displayed on a display screen in the information display terminal device.

11. The information display terminal device according to claim 8, wherein:
the figure parameter creation means integrates figure parameters of a plurality of geometric figures being displayed, determines new figure parameters, and the display control means displays a plurality of geometric figures in an integrated manner on the basis of the determined figure parameters in response to a request from a user that is viewing information through the information display terminal device.

12. The information display terminal device according to claim 8, wherein:
the figure parameter creation means transfers to the display control means a plurality of state data that are used for displaying geometric figures as character information, and the display control means then displays the plurality of state data in the form of character information in response to a request from a user that is viewing information in the information display terminal device.

13. The information display terminal device according to claim 8, wherein:
the figure parameter creation means refers to a conversion table in which formulas and coefficients are defined in order to determine figure parameters.

14. The information display terminal device according to claim 13, wherein:
the formulas and coefficients defined in the conversion table can arbitrarily be set and changed in response to a request from a user.
